(19) United States
(12) Patent Application Publication
(10) Pub. No.: US 2006/0235707 A1
(43) Pub. Date: Oct. 19, 2006

(54) Decision support method and system

(76) Inventors: David B. Goldstein, Cream Ridge, NJ (US); Darryl G. Busch, Eden Prairie, MN (US)

Correspondence Address: Honeywell International, Inc.;Law Department AB2, PO Box 2245, Morristown, NJ, 07962-2245, US

(21) Appl. No.: 11/108,725

(22) Filed: Apr. 19, 2005

(51) Int. Cl. G06Q 99/00

(52) U.S. Cl. 705/1

(57) ABSTRACT

In accordance with the invention, there is a decision support method comprising collecting data about a set of components of an asset, wherein the data comprises information about the status of each component in the set of components. The method also comprises comparing the data to a set of requirements for a use of the asset and estimating a remaining life for each of the components in the set of components based on the status of each of the components and the set of requirements for an intended use of the asset.

### FIELD OF THE INVENTION

The subject matter of this disclosure relates to a decision support method and system. More particularly, the subject matter of this disclosure relates to a methods and systems that can provide meaningful information about the status of an asset.

### BACKGROUND OF THE INVENTION

Large organizations rely upon various assets, such as vehicles, machinery, and other types of equipment, for their operations. For example, effective operations by the military require accurate knowledge of various combat vehicles, weapons systems, etc. Today, many of these assets include various technologies that monitor their status.

Unfortunately, these technologies typically provide a simple Go/No Go determination, such as a warning light, for use of the asset. In addition, known technologies cannot prognosticate (or estimate) how an asset will perform during a current or future use.

For the military, it would be desirable to provide methods and systems that can assist an asset's operator information that indicates the remaining duration of healthy operation specific to a current (or future) mission. In addition, military mission planners and fleet level planners need to understand and plan for mission success (as well as logistic support) based on the most realistic, mission specific, future state of assets. Prognostic technologies coupled with the appropriate decision support tool can increase the reliability and availability of assets while reducing the total cost of ownership.

For example, there is a need to make an expeditionary fighting vehicle (EFV) prognostic system more effective. When an incipient fault or other anomaly is identified in an EFV, it would be desirable to provide a method and system that can predict the effect of the fault on the EFV's operations. This result could be tied to the current (or future) use of the EFV. Moreover, there is a need for a drive train prognostic system on an EFV that can derive parameters that reflect the operating conditions the drive train will be subject to from any present point in time to the desired prediction horizon (i.e., the mission of the vehicle).

Therefore, it would be desirable to provide methods and systems that can prognosticate or predict the healthy operations of assets of an organization. Additionally, there is a need for a method or system that has the ability to optimize the forecasts of an asset's performance, such as by adjusting the algorithms over time, using the same data source.

### SUMMARY OF THE INVENTION

In accordance with the invention, there is a decision support method comprising collecting data about a set of components of an asset, wherein the data comprises information about the status of each component in the set of components. The method also comprises comparing the data to a set of requirements for a use of the asset and estimating a remaining life for each of the components in the set of components based on the status of each of the components and the set of requirements for an intended use of the asset.

According to another embodiment of the invention there is a decision support system comprising a sensor attached to a component of an asset, a computer processor electrically connected to the sensor, wherein the computer processor controls the sensor, receives data about the component, the data comprising information about the status the component, and predicts an estimated remaining life of the component based on the data received from the sensor. The system can also include a graphical user interface that displays information about the remaining life of the components, wherein the information includes an indication of progress of the components towards failure.

According to another embodiment of the invention there is a computer readable medium containing program code that configures a processor to perform a method for decision support, the computer readable medium comprising program code for receiving data about a set of components of an asset, wherein the data comprises information about the status of each component in the set of components program code for comparing the data to a set of requirements for a use of the asset, and program code for estimating a remaining life for each of the components in the set of components based on the status of each of the components and the set of requirements for an intended use of the asset.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 depicts some parts of a vehicle having monitoring systems and various sensors according to various embodiments of the invention.

FIG. 2 depicts a high level flow chart of a prognostics system according to various embodiments of the invention.

FIG. 3 depicts another flow chart of a prognostics system according to various embodiments of the invention.

FIGS. 4A and 4B depict load analyses for at least one component of an asset for a mission according to various embodiments of the invention.

FIG. 5 depicts another flow chart of a prognostics system according to various embodiments of the invention.

FIG. 6A depicts a plot of an exemplary prognostics vector for a component for an asset according to various embodiments of the invention.

FIG. 6B depicts a plot of the exemplary prognostics vector of FIG. 6A projected onto a sample mission according to various embodiments of the invention.

FIG. 7 depicts another flow chart of a prognostics system according to various embodiments of the invention.

FIG. 8 depicts the prognostic results from a fleet analyzed according to various embodiments of the invention.

### DESCRIPTION OF THE EMBODIMENTS

Reference will now be made in detail to the present exemplary embodiments of the invention, examples of which are illustrated in the accompanying drawings. Wherever possible, the same reference numbers will be used throughout the drawings to refer to the same or like parts.

According to various embodiments, the decision support methods and systems described herein can be applied to various assets or a fleet of assets, such as vehicles or other apparatus having mechanical and/or electrical parts. Exemplary vehicles can include land, air, and water vehicles, military, commercial, or private. The decision support and methods systems described herein can use data collected from sensors positioned throughout an asset to prognosticate information about the status of the asset to a user. For example, sensors can be positioned on components and monitor various aspects of these components, such as their temperature, number of cycles, etc. Components of an asset can be any mechanical and/or electrical components of a vehicle, such as the drive shaft, gears, the transmission, clutch, power systems, control systems, etc.

Further, methods and systems of embodiments of the invention can prognosticate the effect that a current and/or future use or mission may have on the asset and the various components and convey a suggested course of action to a user. For example, the system can convert known and possible events that the asset may encounter into quantitative functions. The status of the components can be applied to the quantitative functions to prognosticate how the components will withstand the events. Moreover, the system can provide guidance to a user about whether a particular component can withstand and intended use and the system can also provide an indication of what the status of the components will be after the events.

For purposes of explanation, some of the embodiments will now be explained with reference to an EFV military vehicle. An EFV is an armored tracked amphibious combat vehicle that can carry 17 to 18 combat-equipped infantry (such as a reinforced Marine rifle squad) and has three crewmembers. The EFV can allow the Navy and Marine Corps to link maneuver in ships and maneuver ashore into a single, seamless strike and give both ships and landing forces sufficient sea space for maneuver, surprise, and protection. The EFV can provide armored protected land and water mobility and direct fire support to infantry during combat operations, including a Nuclear/Biological/Chemical (NBC) warfare environment.

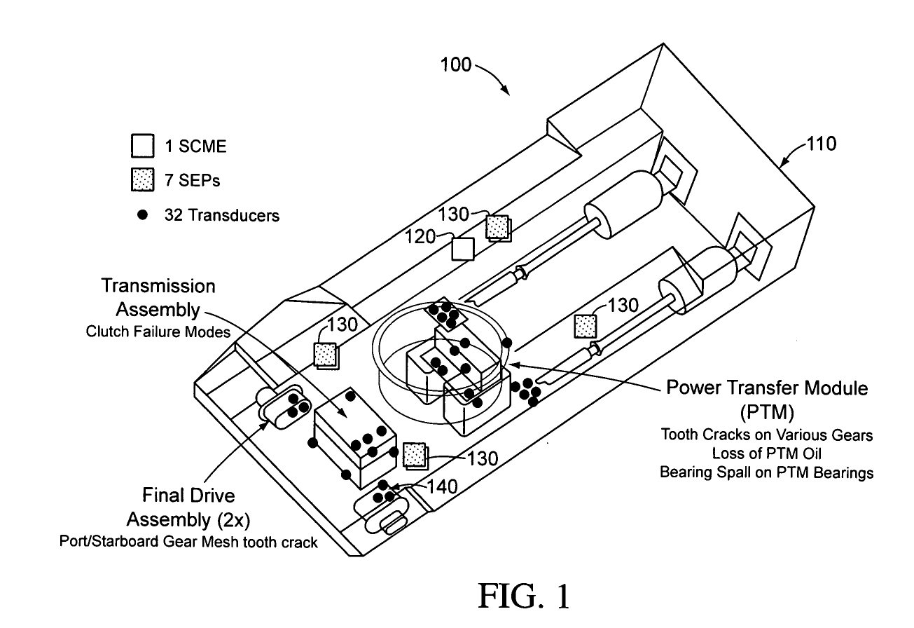

Referring now to FIG. 1, an EFV Drive Train Prognostic System (DTPS) for an EFV is shown. In particular, a DTPS 100 on an EFV 110 comprises a central small form-factor computer processor 120 called a Subsystem Condition Monitoring Engine (SCME), a suite (for example, seven) of Sensors with Embedded Processing (SEP) 130, and a communications and power distribution network. These components may be implemented based on hardware, firmware, and software that is well known to those skilled in the art.

The SEPs 130 and associated transducers 140 and SCME 120 provide the main physical elements of DTPS 100. SEPs 130 can be placed on various components at strategic locations throughout the EFV and can communicate information to SCME 120. For example, SEPs 130 can be placed on drive train elements. SEPs 130 can monitor the drive train using sensors and can perform several portions of the information processing including raw data pre-processing, data extraction, data forwarding, and vehicle state determination. Each SEP 130 can comprise one or more sensors with its associated analog circuitry, a communications system (CANBus), and a small computer.

According to various embodiments, SCME 120 can be one of the primary prognostic activity centers and can process information from SEPs 130. For example, SCME 120 can perform the higher-level processing of information, including detecting signs of faults in the features provided by SEPs 130, isolating the faults, trending, and estimating remaining life. In some embodiments, the estimated remaining life can be based on a set of nominal, pre-defined mission parameters.

Included in the prediction processing can be information from the vehicle data buses. SCME 120 can comprise data storage capability on board. However, in various embodiments, the primary data storage location can be a Mass Memory Unit (not shown in FIG. 1) of the EFV. SEPs 130 and SCME 120 can communicate via a dedicated communications bus. The bus can also carry power from SCME 120 to the SEPs 130. According to various embodiments, system 100 can generate output diagnostic classification and prognostic vectors about the various components of the asset. A prognostic vector can be any set of information that indicates the state of the component and trend in its performance.

Moreover, the output of system 100 can be from the SCME 120 and system 100 can provide detection, diagnostic, and prognostic information as outputs. Still further, depending on the failure mode, system 100 can provide different levels of output (e.g., sensitivity, time to failure, confidence, etc.).

DTPS system 100 can provide information beyond that of a simple Go/No-Go decision. For example, DTPS system 100 can provide a set of prognostic vectors based on more than a nominal mission, and can use the information to prognosticate future vehicle status. Moreover, DTPS system 100 can provide information in a meaningful, user-friendly way.

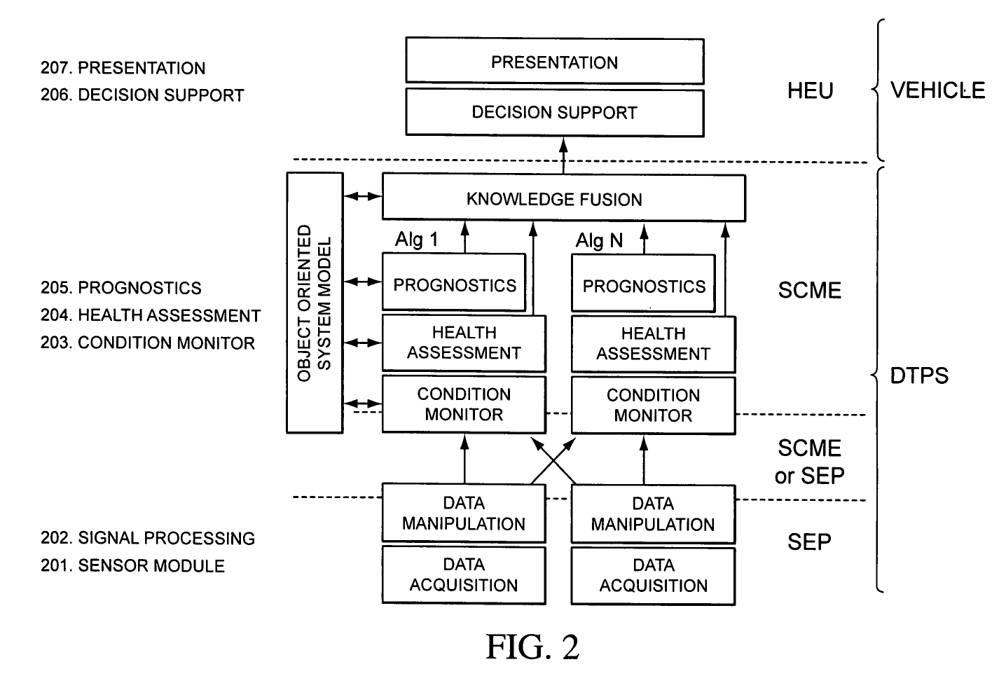

FIG. 2 depicts various layers of a decision support system, such as DTPS system 100. For example, SEPs 130 can provide the sensor modules at 201 and along with onboard memory can provide signal processing at 202. For example, sensor modules 201 can acquire data comprising, for example, information about the status of each of the components to which the sensors are attached. Further, the data can be manipulated and processed at stage 202.

According to various embodiments, other subcomponents, such as those of DTPS system 100, for example, the SCME 120, can provide the health assessment 204 and prognostic layers at 205. Depending on system configuration, a condition monitor at stage 203, can be included with SEPs 130 and/or SCME 120. Health assessment information and condition monitor information can be inputted into various algorithms to provide a prognostics function at 205. This can provide knowledge fusion of the various data received by the system. Various system add-ons can also use the information from the prognostics to provide decision support at stage 206 and user-friendly presentation, such as on a graphical use interface, at stage 207.

According to various embodiments, the decision support system can convert the derived machine-readable prognostic vectors into prognostic outputs that are in a user-readable form. As an example, Table I depicts a user-readable set of prognostic vectors.

TABLE I

| | DSF | BMO | TR | Theta |
|---|---|---|---|---|
| Algorithm 1 | 0.3 | 0.3 | 0.3 | 0.1 |
| Algorithm 2 | 0.4 | 0.2 | 0.0 | 0.4 |
| Algorithm 3 | 0.0 | 0.0 | 0.9 | 0.1 |

DTPS System Output

| | | | |
|---|---|---|---|
| 0.13 | 0.1 | 0.75 | 0.02 |

In Table I, DSF represents water jet drive shaft failure, BMO represents bearing module overload failure, TR represents tip rub failure, Theta represents various other unknown factors, and where the results of algorithms 1-3 provide an indication of the probability of failure. The decision support system can also combine the information obtained from the various algorithms so as to provide a probability of failure of a particular component during a mission based on the information available at that time.

As will be understood, in situations where the units related to the specific impending failure being reported can be easily quantified (i.e., number of shifts of a clutch or revolutions remaining on a gear), the prognostic vector can provide machine translation that will be meaningful information to the user.

According to various embodiments, a display and graphical user interface (GUI)/display layer can be provided. Moreover, in situations where quantification of impending failures are not easily translated into a user-friendly format (i.e., a predicted number of remaining revolutions on a certain gear), decision support systems described herein can provide relevant information about the component in relation to the mission and can provide vehicle health information in other forms, such as color coded shapes.

According to various embodiments, the prognostic output of the systems described herein can be dynamic, and can be updated with the changing mission. Unlike other devices that are based on a single, standard default mission, the systems described herein provide optimal support for the vehicle. For example, the prognostic system can continuously update vectors based on, not only the current vehicle state, but also the expected future vehicle use.

As noted, known methods and systems do not provide decision reasoning beyond a Go/No Go determination. This leaves a significant gap between the predicted future state of the limited number of monitored drive train components (based on a single, standard default mission) and the predicted future state of the vehicle. Without higher level decision aiding, tying the output vectors to the current (or future) use of the vehicle, the information usefulness is limited.

However, various embodiments described herein are dynamic and can provide the vehicle operator in the field properly displayed predictive information identifying such things as, for example, estimated remaining shifts of a clutch. Further, unlike prior devices whose information quickly loses value as the current use and subsequently future use of the vehicle changes with the mission, the methods and systems described herein can provide constantly updated information as the current (and future) missions evolve.

Without knowledge of the future vehicle mission, asset maintainer/mission planners can be limited in their ability to interpret vector outputs and their relevance to current maintenance/planning actions. Therefore, higher-level decision reasoning can be highly beneficial to maximizing a vehicle field time while minimizing its maintenance time.

Concurrent with the need for higher-level decision aid in mission execution and mission planning, the prognostic outputs can provide information sufficient to feed an integrated logistics system. A higher-level logistics aid, integrated with the asset's prognostics system can supplement support systems for the asset.

According to various embodiments, the output of the decision support system described herein can provide a constantly updated vector, directly tied not only to past vehicle use and current vehicle state but also to future vehicle use, future mission execution, and vehicle maintenance.

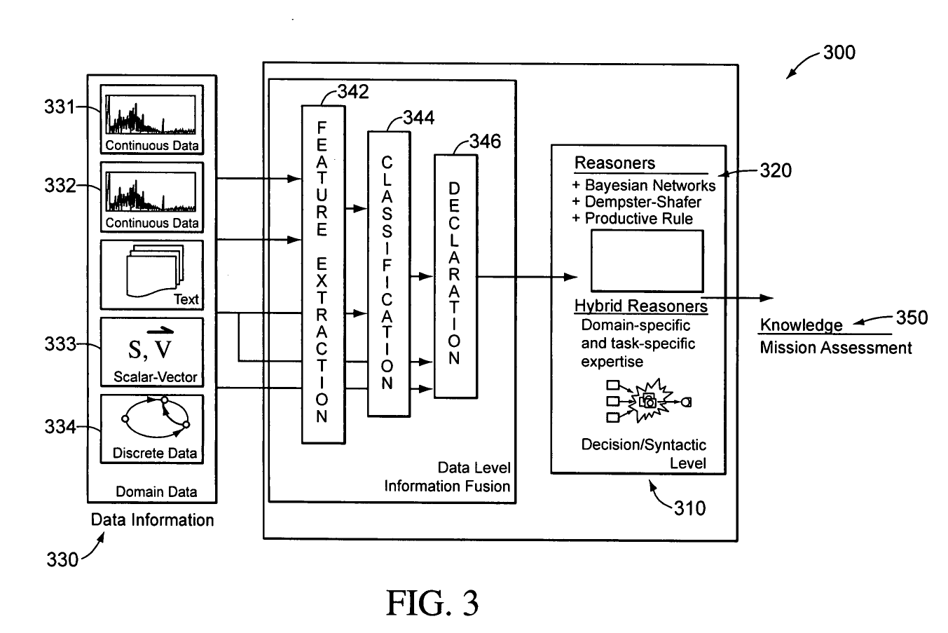

FIG. 3 illustrates an exemplary architecture 300 of a decision support system according to various embodiments of the invention. Architecture 300 can distill data at stage 310 across various algorithms or reasoning paths 320 to provide decision support based on relevant data and/or information obtained from an asset at stage 330. Architecture 300 permits the utilization of a broad range of tools available for data processing and analysis, while preserving the ability to choose the core metrics and controls that permit appropriate trade-off analysis in dynamic command and control decision environments.

For example, relevant data and/or information shown at stage 330 can include domain data, such as, for example, continuously monitored data, shown at 331 and 332. Continuously monitored data 331 and 332 can be obtained, for example, from sensors, such as those of the SEPs 130 described above. Data at stage 330 can also include various scalar and/or vector data about a mission. Data in stage 330 can also include discrete data at 334 about a mission and/or the asset. Relevant features about information 330 can be combined or fused at data level 340. For example, relevant features can be extracted from information 330 at stage 342. At stage 344 the relevant features can be classified. At stage 346 various declarations can be made about the relevant features.

As mentioned, various algorithms can be used to analyze and provide meaningful predictions (or prognostication) based on information 330. According to various embodiments, the prognostication can be provided in the form of a vector. At stage 350 the prognostication can provide knowledge about a mission in a user-friendly format to a user.

The prognostics obtained from the decision support systems described herein can be useful in analyzing various types assets used in various situations. In military applications, the prognostics can be used to assist in the management of the warfighting arsenal. For example, the prognostics can be used to analyze the state of the asset during the following types of missions:

Amphibious:

Waterborne: Portion of maneuver during amphibious assaults, demonstrations, raids, and riverine operations.

Offense:

Hasty Attack: Attack in which preparation time is traded for speed in order to exploit an opportunity.

Deliberate Attack: Action characterized by preplanned coordinated employment of firepower and maneuver to close with and destroy or capture the enemy.

Movement to Contact: Operation designed to gain or reestablish contact with the enemy.

Reconnaissance in Force: Attack designed to discover and/or test the enemy's strength or to obtain other information.

Exploitation: Operations that usually follows a successful attack and is designed to disorganize the enemy in depth.

Pursuit: Operation designed to catch or cut off a hostile force attempting to escape, with the aim of destroying it.

Defense:

Position Defense: Type of defense in which the bulk of the defending force is disposed in selected tactical localities where the decisive battle is to be fought. Principal reliance is placed on the ability of the forces in the defended localities to maintain their positions and to control the terrain between them. The reserve is used to add depth, block, or restore the battle position by counterattack.

Mobile Defense: Defense of an area or position in which maneuver is used with organization of fire and utilization of terrain to seize the initiative from the enemy.

Retrograde:

Delay: Operation in which a force under pressure trades space for time by slowing down the enemy's momentum and inflicting maximum damage on the enemy without, in principle, becoming decisively engaged.

Withdrawal: Planned operation in which a force in contact disengages from an enemy force.

Retirement: Operation in which a force out of contact moves away from an enemy force.

According to various embodiments, an exemplary mission the decision support system can be used as a predictive indicator can be from an EFV Operational Mode Summary/Mission Profile (OMS/MP). Such a mission can be one that is derived from the operations of a Marine Expeditionary Force portrayed in a high-intensity conflict derived from a standard Marine Corps scenario. For example, the scenario can include the first 28 hours and 50 minutes of an enabling force operation, beginning with launch from amphibious shipping, a high-speed surface assault from beyond the horizon, forcible entry into a defended beach, destruction of enemy occupation forces, and seizure of key objectives. The scenario can end with a mission change to defense of the area.

Monitoring machinery loads on the asset and conditions to which the asset will be exposed can provide enhanced regime recognition, such as a better modeling of a mission, and an awareness of component operational profiles. Due to the varying degrees of mission severity and randomness typically observed in military mission profiles, algorithms comprising discrete and/or continuous analytical methods can be used for mission regime recognition and usage monitoring. These methods can range from representing mission profile data with traditional statistical distributions, such as normal, exponential or Weibull, to more specialized regression and correlation techniques that can provide representative missions for specific mission types. Rare/random vehicle operational events, such as waterjet foreign object damage (FOD), specific high gravity maneuvers, etc., which have a discrete occurrence in time, can be modeled based on discrete impulse functions, such as the Poisson impulse function. For a large time macro-scale, the typical mission environment can be represented by a continuous component, while the rare events can be represented by a discrete component.

Rare and random operational events, such as incorrect part installs, accidents, FOD, or extreme maneuvering for example, which can manifested themselves as high dynamic torque impulses, can be modeled as a sequence of impulses by a Poisson (or even a Weibull) shot-noise process model. If the arrival of impulses is modeled by a counting process N(t), then the rare, intermittent event, denoted Xⁱ(t) (superscript i indicates the intermittent nature) can be expressed by the following summation.

$${X}^{i} ( t ) = {\sum }_{j = 1}^{N ( t )} {F}_{j} δ ( t - {t}_{j} )$$

where Fⱼ are the random amplitude of impulse j and δ (t-tⱼ) is the dirac delta unit impulse function with occurrence at time t=tⱼ. The overall resultant mission environment model, denoted X(t), at any t moment during component lifetime can be represented by the superposition of a continuous mission component, denoted X^{c}(t) and defined by a non-normal process, and an intermittent rare event component, denoted Xⁱ(t) and defined by a shot-noise process.

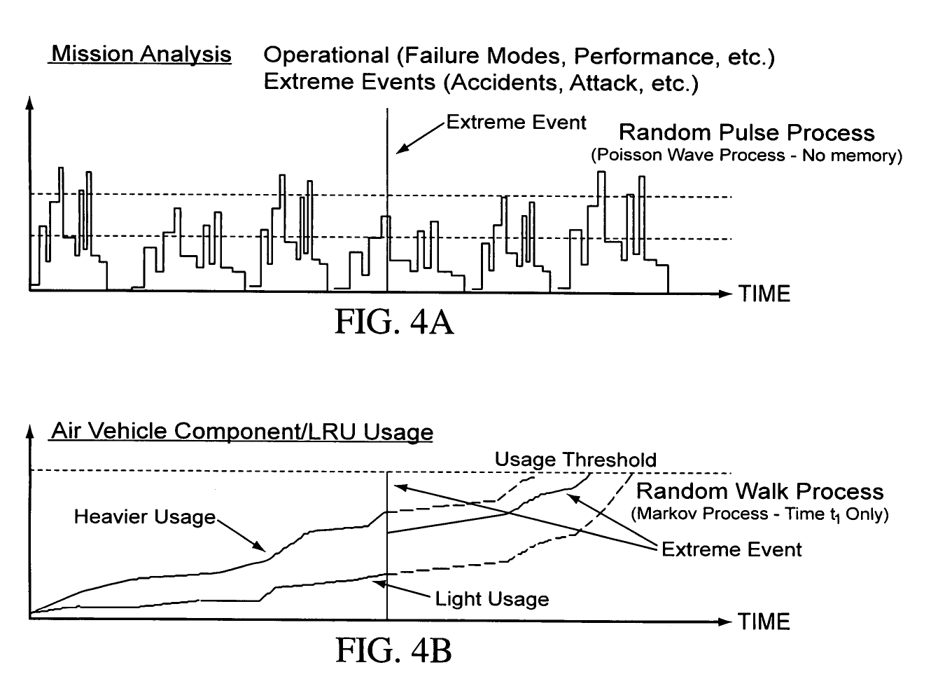

According to various embodiments, the combination of continuous and discrete mission-level modeling paradigms is illustrated in FIGS. 4A and 4B. For example, a continuous mission profile can be simulated or modeled based on distribution statistics developed from mission data. Discrete rare/random events can then be simulated or modeled in parallel and added to the continuous model output based on occurrence rates, also identified from legacy data.

Providing a prognostics-based decision support system such as those described herein can provide a continuous assessment of mission readiness of an asset and can directly support the adaptation of the mission during the asset's deployment.

According to various embodiments, the non-linear nature associated with many structural vehicle component damage mechanisms can be dependent on both the inherent characteristics of the profiles and mission mix types. Significant component damage resulting from the large variability in the operating environment and severity of the missions can directly affect the asset's components lifetimes. In various situations, component life can be driven by fatigue failure modes that can be dominated by unique operational usage profiles or a few, rare, severe, randomly occurring events, including abnormal operating conditions, random damage occurrences, etc. According to various embodiments, the accuracy of this time-variant reliability aspect can be used as a basis of the probabilistic mission simulation process.

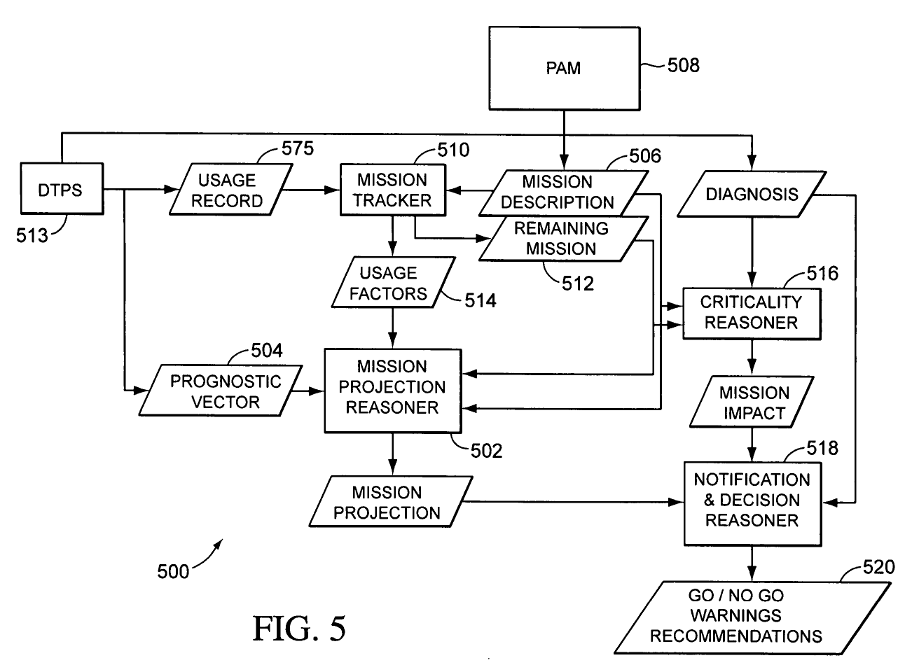

FIG. 5 shows a block diagram of another exemplary architecture 500 of a decision support system according to various embodiments. Architecture 500 includes features of the decision support system, including sections for reasoning and deriving conclusions.

For example, at stage 502 a Mission Projection Reasoner (MPR) inputs the profiles of upcoming missions and the prognostics outputs of the sensors, such as information from a DTPS, and calculates the probability of any component failures occurring during the missions. According to various embodiments, the system does this by “projecting” the usage ordinate of DTPS prognostic vectors 504 onto the description of usage for the upcoming missions, effectively converting usage units into missions. For example, the mission may be as shown in Table II:

TABLE II

| Segment # | Duration | Segment Type | Sub-type |
|---|---|---|---|
| 1 | 10 min. | Transition mode | |
| 2 | 1.5 hr. | Water mode (planning) | SeaState = 1 |
| | | | Temperature = Hot |
| | | | Weather = Sunny |
| 3 | 10 min. | Transition mode | |
| 4 | 2.0 hr. | Land mode (cross | Terrain = Desert |
| | | country) | Temperature = Hot |
| | | | Weather = Sunny |
| | | | Climate = Arid |

In this example, the system may be tracking an impending fault in one of the waterjet planetary gears, and may have produced the prognostic vector shown in Table III. According to various embodiments, the prognostic vector can describe the cumulative probability of failure as a function of a predetermined usage parameter. As shown in Table III, in this example there is a 90% chance of failure in the next 14 hours of water mode operation. The first 8 hours are relatively safe, however, the probability of failure increases rapidly after that time.

TABLE III

| | Hours of Water Operation | | | | | | |
|---|---|---|---|---|---|---|---|
| | 2 | 4 | 6 | 8 | 10 | 12 | 14 |
| Failure Probability (%) | 0.01 | 0.03 | 0.1 | 1 | 10 | 50 | 90 |

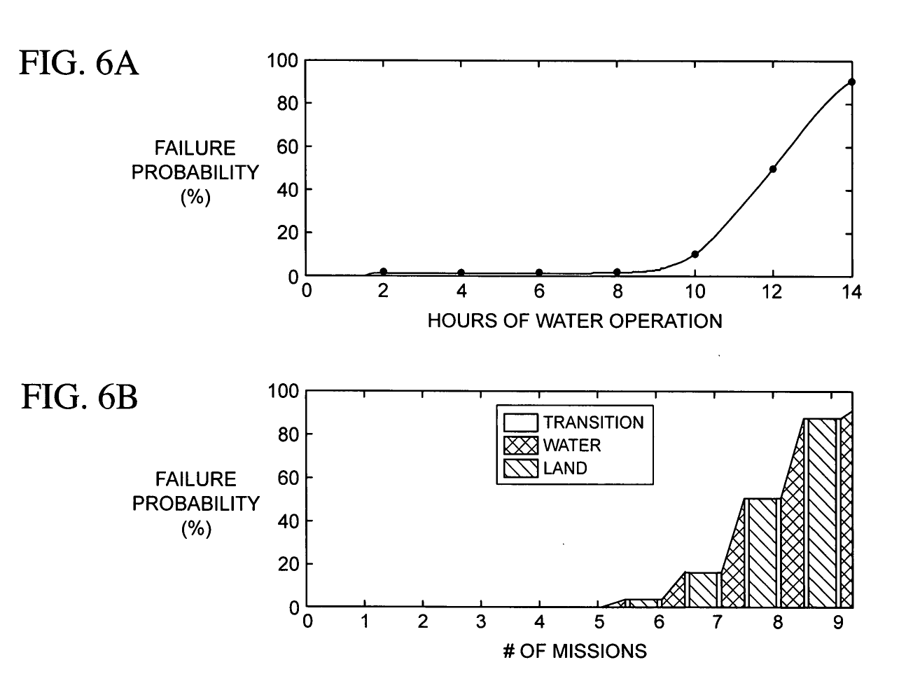

Referring now back to FIG. 5, the MPR can translate “Hours of Water Operation” into missions and segments of missions, and can produce a new prognostic vector. The original vector and new vector are plotted in FIGS. 6A and 6B. Inspection of FIG. 6B shows that the first five missions of this profile are relatively safe, but the probability of failure ramps up quickly in later missions. In this example, failure will likely occur in the 7^{th}, 8^{th}, or 9^{th} mission where the probability ramps from 3.5% to 87%.

The example above was relatively straightforward because the usage unit in the prognostic vector, hours of water mode operation, was readily projected onto the mission. In contrast, there are other failure modes where the projection may require assumptions, with associated uncertainty. One example is prognostication of the clutches, which will have prognostic vectors expressed in numbers of shifts rather than hours. As will be understood, in many instances it is desirable to know the remaining life of a part. However, translating shifts into missions requires assumptions with a high degree of uncertainty. For example, it may be known that there are 5 to 20 engagements of a C2 clutch per hour while the vehicle is in the “mode Land (cross country)”. In this case a crisp prognostic vector that predicts failure in exactly 30 shifts would translate into a projection of failure in 1.5 to 6 missions.

According to various embodiments, these potentially large uncertainties can be addressed by translating usage units into upcoming missions. For example, the user can be provided with additional information, like best and worst case scenarios, and the user can be left to interpret the output (this approach can provide the user with a large volume of information). The user can be provided with an interface that can define the upcoming mission in more exact terms, so that the MPR can make more clear-cut assumptions. The user may also access a software module (not shown) that can estimate the detailed attributes of the upcoming mission from other sources of information, such as map data and the planned path of the upcoming mission to estimate the number of starts, stops, shifts, turns, etc. The user can also rely on recent missions to narrow the uncertainty, based on the assumption that conditions are similar (for example, if the cross country terrain was flat during yesterday's mission and so required few changes in speed and few shifts per kilometer, then bias the translation toward similar conditions in the upcoming mission).

According to various embodiments, the MPR can operate differently during missions versus outside of missions, e.g., before a mission. For example, before a mission the MPR can use the latest prognostic vectors produced by the system and the profile of the upcoming mission. Because the system outputs are based on sensor data collected during operation, the system outputs can be static outside of operations, so the MPR can change its projections if the user were to change the mission profile.

During missions, the MPR can respond to changes in the system outputs, changes in the mission profile, and estimates of how much remains of the current mission. This input can be useful during a mission when the system is predicting that a failure will occur within a few hours. The MPR may know how much of the current mission remains in order to calculate the probability of failure from a particular time until the end of the mission, and thus determine whether the mission can be completed.

Mission Description 506 is a data construct provided to the system by the PAM at 508. The “Perform Prognostics” can use case documents that describe the various parameters that the user can adjust in order to describe the upcoming mission. The descriptiveness of the mission parameterization can be sufficient for the MPR to use for projections before missions. According to various embodiments, the system can include a device that aids the MPR in estimating the number of shifts and speed ranges that will be used. For example, the MPR can use information describing driving conditions, such as Cross-Country/Secondary Road/Primary Road/Urban.

In some cases, the mission parameterization given in the “Perform Prognostics” use case may be less helpful to the MPR during the mission. For example, it may be difficult for the system to deduce what remains in the current mission. One particular parameter, “Mission Hours to Go”, can be used as a count down of the remaining hours in the mission, and that the PAM continuously updates.

A Mission Tracker (MR) at 510 can operate during each mission and can produce two outputs. The first output, Remaining Mission, shown at 512, can estimate what remains of the current mission, and how well the actual mission matches the Mission Description. The second output, Usage Factors, shown at 514, can serve as an indicator of usage factors (e.g. shifts per hour) with narrower uncertainty than the default factors, and that are applicable during this mission and the next few missions.

According to various embodiments, the MR can provide outputs using the Mission Description data provided by the PAM and usage data recorded by the system, shown at 513, and describe the mission so far and recent missions. The usage data can be utilized by the system to produce prognostic vectors. For example, in order to trend a clutch fault, the sensors of the system can count shifts in order to produce the usage axis of the trend. According to various embodiments, the usage data recorded by the system, shown at 515, can be suitable for use by the MT. According to other embodiments, the MT can record its own specialized usage data or a system usage recording function can be extended.

According to various embodiments, the MT can produce Remaining Mission outputs, such as:

Agreement of Mission Description with actual=excellent. Remaining Mission=1 hr. of segment 4, through end of mission.

Agreement of Mission Description with actual=none. Remaining Mission=Unknown.

The MT can produce and record Usage Factor outputs, such as:

This mission: clutch C2 shifts=21-30 per hour (cross country). Clutch C2 shifts=2-5 per hour (primary road).

Next missions: clutch C2 shifts=15-35 per hour (cross country). Clutch C2 shifts=2-7 per hour (primary road).

The Usage Factors labeled “this mission” can be obtained by giving extra weight to usage data obtained during the current mission, and can be most applicable to the current mission. The Usage Factors labeled “next missions” can weight several recent missions, and thus can represent slightly longer-term trends. The Usage Factors produced by the MT can be used by the MPR in lieu of the default parameters with the goal of reducing uncertainty in the projection. The MPR can revert back to the default usage factors if the Usage Factors produced by the MT are deemed inapplicable, as determined by calendar time and/or GPS location.

According to various embodiments, the implementation can use a criticality reasoner, shown at 516, to apply mission specific criticality aids to the decision support tool output. This module can use knowledge of the vehicle and vehicle systems to identify the criticality of a pending failure or the impact that the failure may have on the mission, as labeled in FIG. 5. This module can allow the decision aiding system to provide a level or criticality of an impending fault. Not only with respect to the current system use, but with inherent mission knowledge with respect to future system use.

The Notification and Decision Reasoner module, shown at 518, can contain the higher level decision aiding and notification reasoning. The notification aid can take knowledge of the current and future vehicle mission and apply reasoning to the need for warnings. This capability can assist in avoiding nuisance warnings on systems not critical to the assets' current or future use. The decision reasoner module can merge current and future asset status information with current and future asset use information to provide Go/No-Go type decision aiding as well as more detailed information, as shown at 520. This module also can be used for in-use assets as well as for future mission planning.

According to various embodiments, various algorithms can be used to fuse information and provide decision support. These range, for example, from deterministic expert rule-based and decision trees to implicit algorithms such as neural networks and intelligent agents.

According to various embodiments, decision trees can provide a method of reasoning on symbolic or discrete data sets. For example, embodiments of the invention can use a training set to learn rules for classification. Continuous, discrete, and symbolic data, provided along with classification categories as input for training, can form a data superset. In these embodiments, the methods and systems may find an optimal ordering of the multiple possible subsets contained within the training data to provide the greatest reduction of set entropy with respect to the classification categories and feature space. Although used classically for binary decision problems (Mission Go/No-Go), embodiments of the invention are not limited to a set number of possible outcomes. In some respects, embodiments of the invention produce a result that is much like that of support vector machines. The mapping of missions to prognostic capability can take the form of pruned decision trees obtained by training and using the output rules to construct a consult function.

According to various embodiments, the system can use Case-Based Reasoning (CBR), which is an intuitive approach to developing machine intelligence. Modeled after the way humans learn, CBR seeks to extend knowledge of a domain by applying existing knowledge and techniques, i.e., cases to find a solution for a new problem. Comparison of the results achieved to those desired permits refinement and adaptation of a new technique/case. A CBR system is dynamic and can achieve greater fidelity through usage. Unlike neural networks, genetic algorithms, and many other techniques, a CBR system need not require retraining or re-induction of rules because it learns in place through the experience and development of new cases. A confidence measure is a natural outcome of the CBR reasoning process. Confidence is based on the number of matching cases and similarity measures with respect to the new problem and the total set of matching cases. CBR is a component of the approach to decision support for the asset that can use and extend a baseline and predetermined mission profile subset to support reasoning for mission planning and logistics at the asset level while providing an increasing base of knowledge for extended decision support options at the fleet and command level.

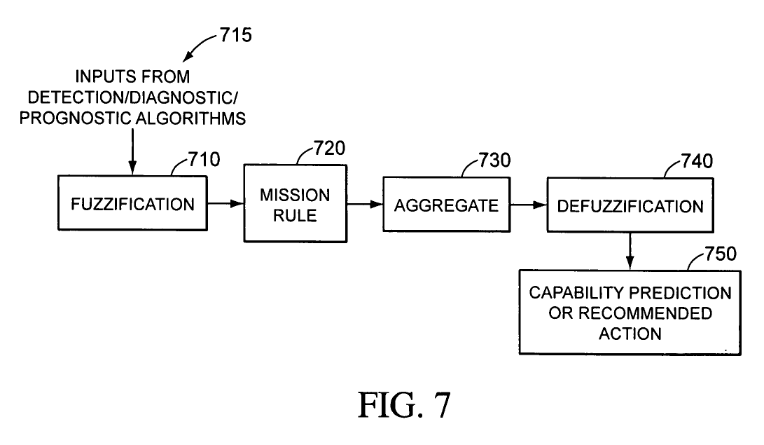

According to various embodiments, a fuzzy rule and inference system is detailed in FIG. 7. As can be seen in FIG. 7 at stage 710, the decision reasoner module takes system/vehicle inputs from Detection and diagnostics and prognostic algorithms at 715 and fuzzifies them. That is, the reasoner module takes the inputs and assigns a real value, such as values between 0 and 1, to represent the degree to which a measurement belongs to a given set considered by the prognostic algorithms. A set of mission rules can then be applied to the fuzzy data at 720. An aggregate of the many mission rules specific to the input set of fuzzy data is developed at 730. This complex aggregate is defuzzified, e.g., assigned a value, at 740 to provide a prediction and decision aid for the current and future asset use at 750.

According to various embodiments, Bayesian Belief Nets allow explicit representation and reasoning about relationships among entities, characteristics of observed entities, physical constraints, and general domain expertise. This method involves representing causal links or relationships using directed acyclic graphs. A directed acyclic graph is a set of nodes and interconnections (no cycles are formed), with an indication of the relationship between nodes. Belief nets allow representation of uncertainty, joint probability relationships, and explicit connections between data and inference.

Bayesian Inference can be used to determine the probability that a diagnosis is correct or to update a prediction, given a piece of a priori information. Analytically, this process can be described as follows:

$$P ( {f}_{1} \vert {O}_{n} ) = \frac{P ( {O}_{n} \vert {f}_{1} ) \cdot P ( {f}_{1} )}{{\sum }_{f = 1}^{n} P ( {O}_{n} \vert {f}_{1} ) \cdot P ( {f}_{1} )}$$

Where P(f₁|Oₙ) is the probability of fault (f) given a diagnostic output, (O), P(f₁|Oₙ) is the probability that a diagnostic output (O) is associated with a fault (f), and P(f₁) is the probability of the fault (f) occurring.

Probabilistic graphical models (PGMs), including Bayesian networks and Markov random fields, are a way to represent uncertainty knowledge and are inference techniques in statistical inference and machine learning. Exact algorithms (and many approximate techniques) for solution of general PGMs are intractable. According to various embodiments, Pearl's belief propagation (BP) algorithm (an implementation of relatively simple variational approximation techniques) can be used for simulated sensor networks, including failure of network nodes, and conditions under which the environment is rapidly changing.

According to various embodiments, there may be an infinite number of operating conditions that can directly affect the system. Real time monitoring of on-vehicle subsystems can provide a method to detect an incipient fault, but in order to more accurately forecast time to failure, the contemporaneous operating conditions of the vehicle should be known. This data can most readily be derived from the mission of the vehicle.

According to various embodiments, manageable operating scenarios can be handled in a number of ways, such as through the categorization or classification of various mission scenarios. An up-front effort to classify the mission scenarios can provide great benefit when optimizing an on-vehicle prognostic algorithm. The systems described herein can provide the ability to adjust, in a deterministic manner to changing mission scenarios, and in addition, they can augment the real-time monitoring of on-vehicle parameters (e.g. RPM, throttle position, waterjets engaged, etc.).

According to various embodiments, the coupling of mission data to systems described herein can provide integrity to the data. Eventually, the data can be used to provide users, such as theatre commanders, with a knowledge base for optimum asset allocation on a near real-time basis.

According to various embodiments, systems that can communicate information across the enterprise, for example, from the vehicle to the maintenance floor or from the mission planner to the logistics centers, can be a complex task that requires integration of a diverse set of tools and processes. The ability to use the systems in place, without unacceptable perturbations of functioning processes, is important to cross-discipline integration. Identifying the right kinds of information needed between organizations and selecting simple open protocols to transmit this information can help to make the wide-scale integration feasible.

Some of the benefits that are realizable from the systems described herein include improved safety associated with operating and maintaining machinery on Department of Defense Platforms; reduced life cycle costs of machinery from installation to decommissioning; ability to optimize maintenance intervals for specific machines or groups of machines and prioritization of tasks to be performed during the planned maintenance outage; increased up-time/availability of all assets on a platform; provision of engineering justification for scheduling maintenance overhauls with corresponding economic benefits clearly identifiable; examination of what mission profile mixes have the most damaging effects on particular air vehicle system/subsystem/LRU failure modes; directed engineering-based relationships between air vehicle mission operating variables and resulting system/subsystem/LRU damage; ability to relate aircraft component damage profiles for optimizing opportunistic maintenance intervals and task prioritization; and justification for fleet planning and/or maintenance scheduling according to sound engineering principles with the corresponding benefits clearly identified.

Further, some benefits of implementing the mission assistance and interpretive prognostic technologies include improved mission assurance and enhanced safety. For example, the systems described herein can provide the increased confidence that an EFV can meet its mission objective and not fail due to component degradation or aging related weaknesses. In addition, the modeling and fusion of multiple sources of usage and diagnostic information can provide improved accuracy on predicted performance and confidence in Go/No Go decisions.

Further, there is enhanced safety. In particular, the loss of control or failure of an EFV represents a potential safety hazard for operators and other personnel.

According to various embodiments, systems described herein can be applicable to programs within the Department of Defense, including the Joint Strike Fighter Prognostics and Health Management (JSF PHM); US Army Diagnostic Improvement Program (ADIP) and Future Combat Systems (FCS); USAF Versatile Advanced Affordable Turbine Engine (VAATE) effort; numerous NAVSEA shipboard Condition-Based Maintenance (CBM) and DD(X) Mission Readiness (MRSS) efforts; NAVAIR helicopter Health and Usage Monitoring Systems (HUMS) programs; DARPA Asset Readiness Prognostics; the USMC EFV DTPS; and other programs that have operations that require accurate knowledge of an asset's health. This knowledge, when combined with the anticipated effects of the planned mission, is vital for optimal planning and mission execution. Moreover, systems described herein can provide advanced prognostic and decision support techniques to enable the right asset on the right mission at the right time.

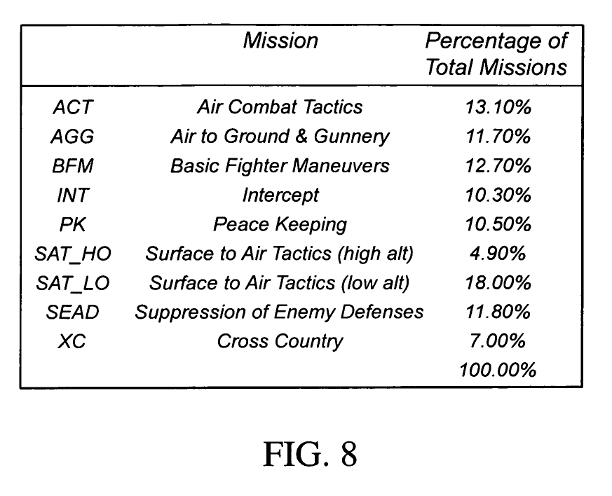

Another example of the mission and usage monitoring capabilities that can be analyzed for use in EFV is provided. In this example, the mission analysis data from an F-16/F11-129 engine was analyzed to develop statistical descriptions of operating conditions that relate to engine/aircraft usage. This statistical analysis examined the field of usage into one of eight different mission types. During the period of data collection, 29 aircraft (principally engine) parameters were measured and analyzed. Some of the results from the fleet analyzed are shown in FIG. 8.

In this example, several data processing measures were employed during the analysis to consolidate the data from many flights into the mission profile description types shown in FIG. 8. First, each flight was examined statistically to group it into a particular mission type (based on average statistics). Second, small excursions that are too small to cause damage or influence the mission type were removed. All of the representative flights include preflight and post-landing idle and taxi data.

Although this study focused on engines, a similar approach can be used to capture mission stressor variables for drive train prognostics purposes. In terms of engine usage related to key component fatigue drivers, six parameters were selected from the mission analysis to further investigate. For each mission type and each parameter, the data was analyzed in two ways. First, a histogram was calculated for the frequency of the values of each parameter. The population of each bin indicates the total amount of time that the parameter was calculated for values of each parameter. A criterion of ±1.5% of the parameter value was used for measurement of dwell periods. The population of each bin represents the number of times that the parameter remained constant for the period defined by that bin.

According to various embodiments, there can be a web-based application for assets, such as advanced helicopter diagnostics and prognostics. The helicopter diagnostic and prognostic system can be accessed via an active web page continuously linked to required engine data and information. In various embodiments, component damage levels for an entire fleet of engines can be evaluated through a “fleet management” link on the website.

According to various embodiments, there can be a flight line avionics maintenance and diagnostics system in the form of a portable instrumentation package for multiple programs, including RAH-66 Comanche, F-22 IMIS, Maverick/Harpoon, and C-17 Agile. A reasoning system can identify the optimum test strategy and can link to the appropriate section of an interactive electronic technical manual. These rugged portable maintenance aids can be adapted to support the open system architecture, advanced data fusion and collaborative diagnostics program described herein. Systems disclosed herein can also be adapted for commercial applications.

According to various embodiments, there can be a systems-level approach to diagnostics and prognostics in an Avionics Health Management (AHM) package. Various embodiments can include extensible markup language (XML) open communications architectures that allow information and communication continually between on-board and off-board systems, an XML enabled evidence database for automated evidence storage and retrieval, innovative knowledge exchange and fusion modules to support high-level reasoning, advanced on-board and at-wing diagnostic and prognostic reasoners for decision support, and continuous learning to support system growth and adaptability. Coordinated efforts with the development of an Automated Test Meta-Language (ATML) and the joint Agile Rapid Global Combat Support (ARGCS) initiative can bring better supportability to the warfighter and complement/enhance current developments in re-configurable test program sets and synthetic signal stimulation for advanced at wing diagnostics.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A decision support method comprising:
collecting data about a set of components of an asset, wherein the data comprises information about the status of each component in the set of components;
comparing the data to a set of requirements for a use of the asset; and
estimating a remaining life for each of the components in the set of components based on the status of each of the components and the set of requirements for an intended use of the asset.

2. The decision support method according to claim 1 further comprising:
monitoring the set of components during the intended use of the asset so as to update the status of the components; and
estimating the remaining life for the components based on the updated status of the components.

3. The decision support method according to claim 1 further comprising:
outputting to a user information about the remaining life of the components, wherein the information includes more than a Go/No-Go recommendation.

4. The decision support method according to claim 1, wherein the estimate of remaining life of the components is determined using a vector comprising information about the intended use of the asset, and wherein the intended use of the asset includes a current use of the asset and a future use of the asset.

5. The decision support method according to claim 1, wherein the estimate is determined using an algorithm comprising at least one of a normal statistical distribution, an exponential statistical distribution, a Weibull statistical distribution, a regression analysis, and a correlation analysis.

6. The decision support method according to claim 5, wherein the estimate is determined using an algorithm further comprises using a Poisson impulse function to model a discrete event in the use of the asset.

7. The decision support method according to claim 1, wherein the estimate provides an indication of the probability of failure of at least one component in the set of components during the intended use of the asset.

8. A decision support system comprising:
a sensor attached to a component of an asset;
a computer processor electrically connected to the sensor, wherein the computer processor controls the sensor, receives data about the component, the data comprising information about the status the component, and predicts an estimated remaining life of the component based on the data received from the sensor; and
a graphical user interface that displays information about the remaining life of the components, wherein the information includes an indication of progress of the components towards failure.

9. The decision support system according to claim 8, wherein the recommendation is based on a comparison of the data received from the sensor to a set of requirements of an intended use of the asset.

10. The decision support system according to claim 8, wherein the computer processor uses an algorithm comprising at least one of a normal statistical distribution, an exponential statistical distribution, a Weibull statistical distribution, a regression analysis, and a correlation analysis to predict the remaining life of the component.

11. A computer readable medium containing program code that configures a processor to perform a method for decision support, the computer readable medium comprising:
program code for receiving data about a set of components of an asset, wherein the data comprises information about the status of each component in the set of components;
program code for comparing the data to a set of requirements for a use of the asset; and
program code for estimating a remaining life for each of the components in the set of components based on the status of each of the components and the set of requirements for an intended use of the asset.

12. The computer readable medium containing program code according to claim 11 further comprising:
program code for monitoring the set of components during the intended use of the asset so as to update the status of the components; and
program code for estimating the remaining life for the components based on the updated status of the components.

13. The computer readable medium containing program code according to claim 11 further comprising:
program code for outputting to a user information about the remaining life of the components, wherein the information includes more than a Go/No-Go recommendation.

14. The computer readable medium containing program code according to claim 11, wherein the estimate of remaining life of the components is determined using a vector comprising information about the intended use of the asset, and wherein the intended use of the asset includes a current use of the asset and a future use of the asset.

15. The computer readable medium containing program code according to claim 11, wherein the estimate is determined using an algorithm comprising at least one of a normal statistical distribution, an exponential statistical distribution, a Weibull statistical distribution, a regression analysis, and a correlation analysis.

16. The computer readable medium containing program code according to claim 11, wherein the estimate is determined using an algorithm further comprises using a Poisson impulse function to model a discrete event in the use of the asset.
